(19) United States
(12) Patent Application Publication
(10) Pub. No.: US 2024/0263500 A1
(43) Pub. Date: Aug. 8, 2024

(54) FITTING FOR MOVABLY MOUNTING A PIVOTING ELEMENT RELATIVE TO A STATIONARY SUPPORT

(71) Applicant: Julius Blum GmbH, Hoechst (AT)

(72) Inventor: Irmela Mara Geller, Dornbirn (DE)

(21) Appl. No.: 18/639,384

(22) Filed: Apr. 18, 2024

Related U.S. Application Data
(63) Continuation of application No. PCT/AT22/60353, filed on Oct. 13, 2022.

(30) Foreign Application Priority Data
Nov. 26, 2021 (AT) A 50949/2021

(51) Int. Cl. E05D 7/00; E05D 3/06; E05D 5/02; E05D 11/10

(52) U.S. Cl. CPC E05D 7/0009; E05D 3/06; E05D 5/0276; E05D 11/1007; E05Y 2900/20

(57) ABSTRACT

A fitting for movably supporting a pivoting element relative to a stationary carrier includes a first fitting portion and a second fitting portion pivotally connected to the first fitting portion via a hinge lever. The first fitting portion includes a base body and a bearing body adjustable relative to the base body, and the hinge lever is supported on the bearing body. A first adjustment device is provided for adjusting the bearing body relative to the base body in a first adjustment direction, and a second adjustment device is provided for adjusting the bearing body relative to the base body in a second adjustment direction transverse to the first adjustment direction. The two adjustment devices are coupled to each other such that the bearing body, upon an adjustment in the first adjustment direction, is also entrainable at least partially in the second adjustment direction.

The present application is a continuation of International Application PCT/AT2022/060353 filed Oct. 13, 2022. Thus, all of the subject matter of International Application PCT/AT2022/060353 is incorporated herein by reference.

### BACKGROUND OF THE INVENTION

The present invention relates to a fitting for movably supporting a pivoting element, in particular a furniture part, a door or a window, relative to a stationary carrier, the fitting comprising:
a first fitting portion configured to be fixed to a, preferably substantially horizontally aligned, panel of the carrier,
a second fitting portion configured to be fixed to the pivoting element, the second fitting portion being pivotally connected to the first fitting portion via at least one hinge lever,
wherein the first fitting portion includes at least one base body and at least one bearing body adjustable relative to the base body, the at least one hinge lever being supported on the bearing body,
a first adjustment device for adjusting the at least one bearing body relative to the base body in a first adjustment direction, preferably in a direction extending transversely to a front face of the first fitting portion,
at least a second adjustment device for adjusting the at least one bearing body relative to the base body in a second adjustment direction extending transversely to the first adjustment direction, preferably in a direction extending parallel to the front face of the first fitting portion.

WO 2016/174071 A1 discloses a furniture hinge for pivotally supporting a furniture door, in which the carcass-sided fitting body is configured to be received within a horizontally aligned furniture panel of a furniture carcass. On the carcass-sided fitting portion, two adjustment devices are arranged for adjusting a bearing body relative to an outer housing in a depth direction and in a lateral direction. On the door-sided fitting portion, a further adjustment device is provided for adjusting the furniture door in a height direction.

WO 2020/212086 A1 shows a similar furniture hinge with fitting portions configured to be integrated into furniture panels. On the carcass-sided fitting portion, a first adjustment device for depth-adjustment and a second adjustment device for lateral adjustment are provided.

KR 101458549 B1 discloses a support device for a pivotable door, in which a hinge journal of the door can be coupled to a recess of a pivoting member. The pivoting member is pivotally supported relative to a base body to be fixed to the floor. For adjusting a position of the door, two lateral pins are provided. When now a first pin of the two lateral pins is rotated, this also leads to an adjustment on the other side, due to the pivotal support of the pivoting member. The adjustment directions caused by the two lateral pins extend parallel to each other.

WO 2020/006587 A1 discloses a furniture fitting for movably supporting a pivoting element in the form of a furniture door, in which the carcass-sided fitting portion for fixing to the stationary carrier includes a mounting member configured to be integrated in a furniture panel. In a first step, the mounting member is to be pre-mounted to or on the furniture panel of the carrier. In a second step, the furniture door can be releasably connected to the mounting member pre-mounted to the carrier via a coupling member. Moreover, three rotationally supported operating elements are provided for adjusting the coupling member relative to the mounting member in a three-dimensional member when the coupling member is in a connected condition with the mounting member. In order to adjust the coupling member within the mounting member, a certain play of the coupling member within the mounting member in three movement directions has to be provided. However, this three-dimensional play of the coupling member within the mounting member can lead to an instability and to a rattling of the coupling member, and a defined movement behavior of the movable furniture part can no longer be ensured.

### SUMMARY OF THE INVENTION

It is an object of the present invention to propose a fitting of the type mentioned in the introductory part, thereby avoiding the above-discussed drawbacks.

According to the invention, the two adjustment devices are coupled to each other such that the bearing body, upon an adjustment of the bearing body in the first adjustment direction with the aid of the first adjustment device, is also entrainable at least over a region in the second adjustment direction.

In other words, a coupling between the two adjustment devices is provided, namely such that an actuation of an adjustment device in a first movement direction also leads to an adjustment of the bearing body in the second movement direction (and preferably also vice-versa). Therefore, an entanglement of the two adjustment devices is provided, leading to a significant reduction of play of the bearing body within the base body.

Preferably, the two adjustment devices are coupled to each other such that the bearing body, upon an adjustment of the bearing body in the second adjustment direction with the aid of the second adjustment device, is also entrainable at least over a region in the first adjustment direction.

Accordingly, in contrast to the prior art according to the WO 2020/006587 A1 reference mentioned in the introductory part, there are at least two adjustment devices coupled to each other, instead of adjustment devices operating independently from each other. The adjustment of the first adjustment device in a first adjustment direction also leads to a movement of the bearing body in the second adjustment device (and preferably also vice-versa). This may look as a drawback with respect to the WO 2020/006587 A1 reference at a first sight. However, in this way, the play of the bearing body within the base body can be reduced and a person can certainly find a compromise of an adjustment in which the position of the bearing body in the first adjustment direction and in the second adjustment direction is both suitable.

According to a preferred embodiment, the at least one bearing body, in a connected condition with the base body, is pivotally supported relative to the base body about a pivoting axis, and the bearing body is movable by an actuation of at least one adjustment device, preferably by an actuation of both adjustment devices, about the pivoting axis.

### BRIEF DESCRIPTION OF THE DRAWINGS

Further details and advantages of the present invention result from the following description of figures, in which:

FIG. 1 shows a perspective view of an item of furniture with a carrier and with a pivoting element configured to pivot relative to the carrier,

FIG. 2 shows the carrier and the fitting in a separated condition,

FIG. 3 shows the mounting body and the base body of the first fitting portion in a separated condition from each other,

FIG. 4 shows the locked condition between the base body and the mounting body,

FIG. 5a, 5b shows the first fitting portion with the base body and the bearing body in a top view and in a perspective view,

FIG. 6a-6d show the adjustments of the first adjustment device and of the second adjustment device with different positions of the pivoting element relative to the stationary carrier, and

FIG. 7a, 7b show the first fitting portion with the base body, the bearing body and with an adjustment device according to a slightly modified embodiment.

### DETAILED DESCRIPTION OF THE INVENTION

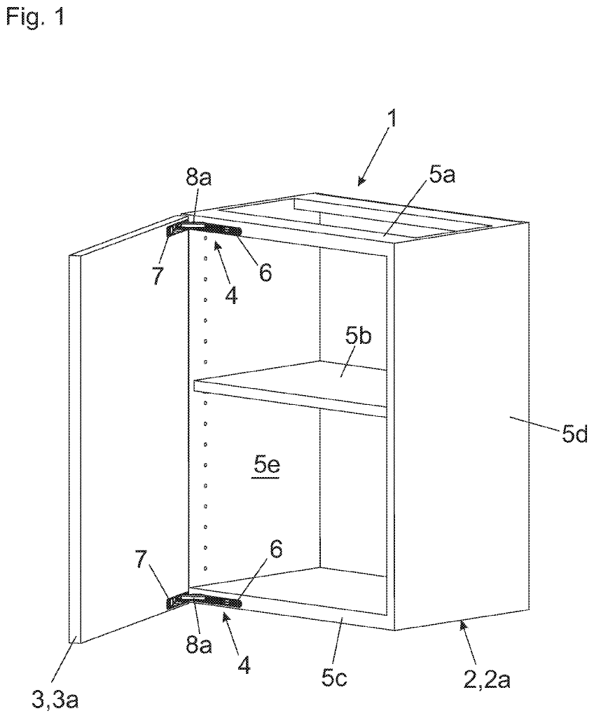

FIG. 1 shows a perspective view of an item of furniture 1 with a stationary carrier 2 (for example in the form of a furniture carcass 2a), in which a pivoting element 3 (for example a movable furniture part 3a, a flap, a door, a window or the like) is pivotally supported by at least one fitting 4 relative to the carrier 2 about an axis. Preferably, the axis extends vertically in a mounted position.

The carrier 2 includes a plurality of panels 5a-5e, and the first fitting portion 6 of the fitting 4 is configured to be integrated in one of the panels 5a-5e of the carrier 2 (thus, for example, into the top panel, into the bottom panel and/or into a shelf arranged between the top panel and the bottom panel).

Of course, it is also possible to arrange the fitting 4 in or on the vertically extending panels 5d, 5e, so that the pivoting element 3, in a mounted condition, is pivotally supported relative to the carrier 2 about a horizontally extending axis.

In the shown embodiment, the first fitting portion 6 of the fitting 4 is substantially entirely received within a recess of the panels 5a, 5c, and/or that the second fitting portion 7 of the fitting 4 is substantially entirely received within a further recess of the pivoting element 3.

The pivoting element 3 can be formed of a panel-shaped material (for example wood, plastic, fiberboard, a glass panel or the like).

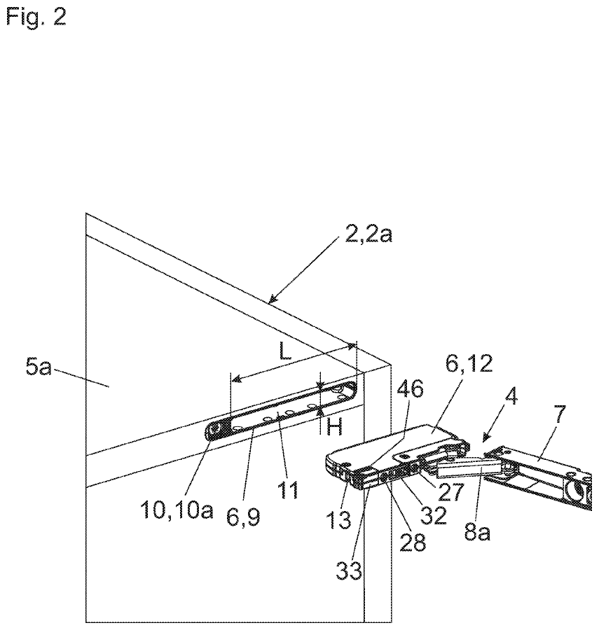

FIG. 2 shows the carrier 2 and the fitting 4 in a separated condition from each other. The first fitting portion 6 is to be fixed within or to a panel 5a-5e of the carrier 2. For this purpose, the first fitting portion 6 includes a mounting body 9 which is insertable into a recess of the panel 5a and which can be fixed to the panel 5a via at least one fastening device 10.

The fastening device 10 can be realized according to different embodiments and can include, for example, at least one hole for the passage of a screw, at least one eccentric or at least one clamping screw. In the shown embodiment, the fastening device 10 of the mounting body 9 includes at least one movable, preferably pivotable, fastening element 10a. By an actuation of the fastening element 10a with the aid of a tool, at least one clamping member (not shown) of the fastening device 10 is connectable to the panel 5a in a frictionally-locked manner.

In a first step, the mounting body 9 is to be pre-mounted to the panel 5a via at least one fastening device 10. The mounting body 9 includes a, preferably pocket-shaped, housing 11 in which a base body 12 of the first fitting body 6 can be inserted, the base body 12 being configured to be releasably locked within the housing 11 via at least one locking device 13.

Within the base body 12 of the first fitting portion 6, a bearing body 32 is received, and a position of the bearing body 32 relative to the base body 12 is adjustable by at least two adjustment devices 27, 28. Preferably, the base body 12 can be configured substantially cuboidal.

By the first adjustment device 27, the bearing body 32 is adjustable relative to the base body 12 in a first adjustment direction M1, preferably in a direction extending transversely to a front face 33 of the first fitting portion 6. Preferably, the bearing body 32 is adjustable by the first adjustment device 27 in a direction extending substantially perpendicular to the front face 33 of the first fitting portion 6. As a result, the pivoting element 3 connected to the second fitting portion 7 is adjustable relative to the stationary carrier 2 in a depth direction.

By the second adjustment device 28, the bearing body 32 is adjustable relative to the base body 12 in a second adjustment direction M2 extending transversely to the first adjustment direction M1, preferably in a direction extending substantially parallel to the front face 33 of the first fitting portion 6. In this way, the pivoting element 3 connected to the second fitting portion 7 is adjustable relative to the stationary carrier 2 in a lateral direction.

The bearing body 32 of the first fitting portion 6 is pivotally connected to the second fitting portion 7 via at least one hinge lever 8a. The second fitting portion 7 can be configured to be partially, preferably substantially entirely, countersunk within a recess of the pivoting element 3. Alternatively, the second fitting portion 7 can be arranged entirely outside of a material thickness of the pivoting element 3 in a mounted condition.

The housing 11 of the mounting body 9 includes a longitudinally-shaped recess for receiving the base body 12. The housing 11 has a height extension H and a longitudinal extension L, and the longitudinal extension L of the housing 11 can be at least three times, preferably at least six times, larger than the height extension H.

The, preferably substantially cuboidal, base body 12 has a dimensioning corresponding to the height extension H and to the longitudinal extension L, and the base body 12 is configured to be received within the housing 11 of the mounting body 9 approximately in a form-locking manner.

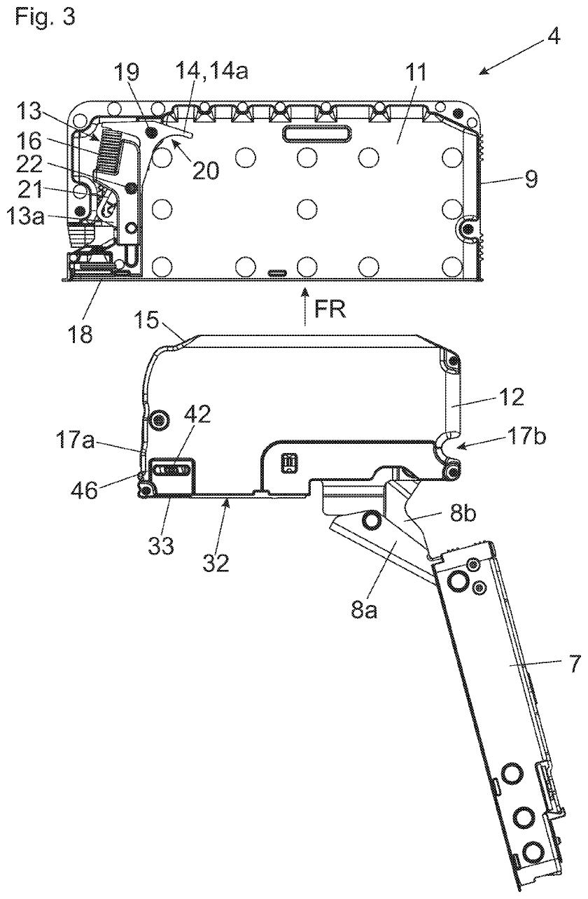

FIG. 3 shows the mounting body 9 and the base body 12 of the first fitting portion 6 in a separated condition from each other.

By at least one locking device 13, the base body 12 can be releasably locked to the mounting body 9. The at least one locking device 13 includes an ejection device 14 for at least partially ejecting the base body 12, during of an unlocking, by a force of a spring element 16, preferably by a compression spring, out from the housing 11 of the mounting body 9.

The base body 12, when being mounted, is insertable into the housing 11 of the mounting body 9 in an assembling direction FR, and the base body 12 is at least partially ejectable by the ejection device 14 in a direction opposite the assembling direction FR during an unlocking operation.

The housing 11 of the mounting body 9 can include a front face 18, and the base body 12, when being mounted, is insertable into the housing 11 of the mounting body 9 in a direction extending substantially perpendicular to the front face 18. The front face 18 of the housing 11, in a mounted condition, extends substantially parallel to a front narrow side of the panel 5a of the carrier 2.

In the shown embodiment, at least one anchor 20 is provided, the at least one anchor 20 being pivotable about a pivoting axis 19. The anchor 20 includes a shaft and two arms protruding from the shaft. The spring element 16 engages on a first arm of the anchor 20, the ejection lever 14a is arranged on a second arm of the anchor 20, and the locking lever 13a is arranged on the shaft of the anchor 20.

The ejection lever 14a of the ejection device 14 for ejecting the base body 12 out from the mounting body 9 is configured to bear against a rear side 15 of the base body 12.

The locking device 13 can include at least one pivotable locking lever 13a for releasably locking the base body 12. Preferably, the at least one locking lever 13a
has a locking position and an unlocking position, and the at least one locking lever 13a is arranged in the unlocking position for mounting the base body 12, and/or
is pressurized by at least one spring element 16, preferably a helical spring, preferably the at least one locking lever 13a is movable against a force of the spring element 16 when the base body 12 is inserted into the housing 11 of the mounting body 9, and can be releasably locked with the base body 12 upon a continued insertion movement into the housing 11, and/or
is configured to be locked via a control curve 21 and a control element 22, preferably a cylindrical pin, movable along the control curve 21, and/or
is configured to be releasably locked with a recess 17a, 17b of the base body 12, and/or
is arranged within or on the mounting body 9 of the first fitting portion 6.

Preferably, the bearing body 32 can be substantially entirely received within the base body 12, and the bearing body 32 is pivotally connected to the second fitting portion 7 via at least one hinge lever 8a, preferably via at least two hinge levers 8a, 8b.

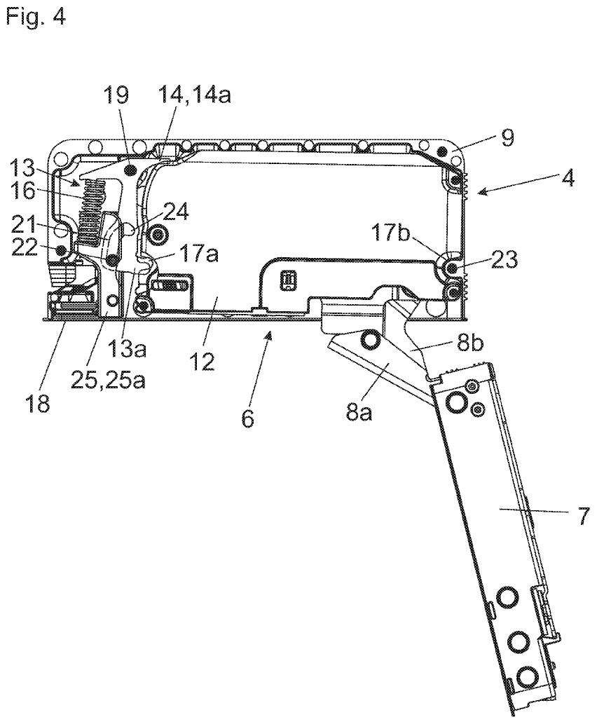

FIG. 4 shows the locked position between the base body 12 and the mounting body 9. For mounting, the base body 12 has been pushed into the housing 11 of the mounting body 9, whereby the control element 22 (for example a cylindrical pin) has been moved out from a locking recess 24 of the control curve 21. In this way, the locking lever 13a is moved about the pivoting axis 19 by a force of the relaxing spring element 16 and is locked into the lateral recess 17a of the base body 12. On the opposing side face, the base body 12 includes a further recess 17b which is in engagement with an engagement element 23 of the mounting body 9.

It can be seen that the locking lever 13a of the locking device 13 and the ejection lever 14a of the ejection device 14 are formed together so as to have an integral one-piece configuration, and are preferably prestressed by a same, single spring element 16.

The locked position between the base body 12 and the mounting body 9 is again releasable by a release device 25 having a movable release element 25a. Preferably, the release element 25a
is linearly displaceably supported, and/or
is configured to be actuated by a tool, and/or
is movable against a force of a spring element 16 in a release position in which the base body 12 is releasable, and/or
is movable in a direction extending perpendicular to a front face 18 of the mounting body 9, and/or can be actuated from a front face 18 of the mounting body 9.

For releasing the locking, the release element 25a is pushed into the housing 11 of the mounting body 9 with the aid of a tool. As a result, the control element 22 is moved against a force of the spring element 16 along the control curve 21 and the spring element 16 is tensioned.

By moving the control element 22 along the control curve 21, the locking lever 13a of the locking device 13 is also moved out from the recess 17a of the base body 12, and the ejection lever 14a of the ejection device 14 is tilted about the pivoting axis 19. Eventually, the control element 22 again jumps into the locking recess 24 of the control curve 21. Therefore, the base body 12 can be ejected out from the housing 11 of the mounting body 9 by the ejection lever 14a and by a force of the relaxing spring element 16.

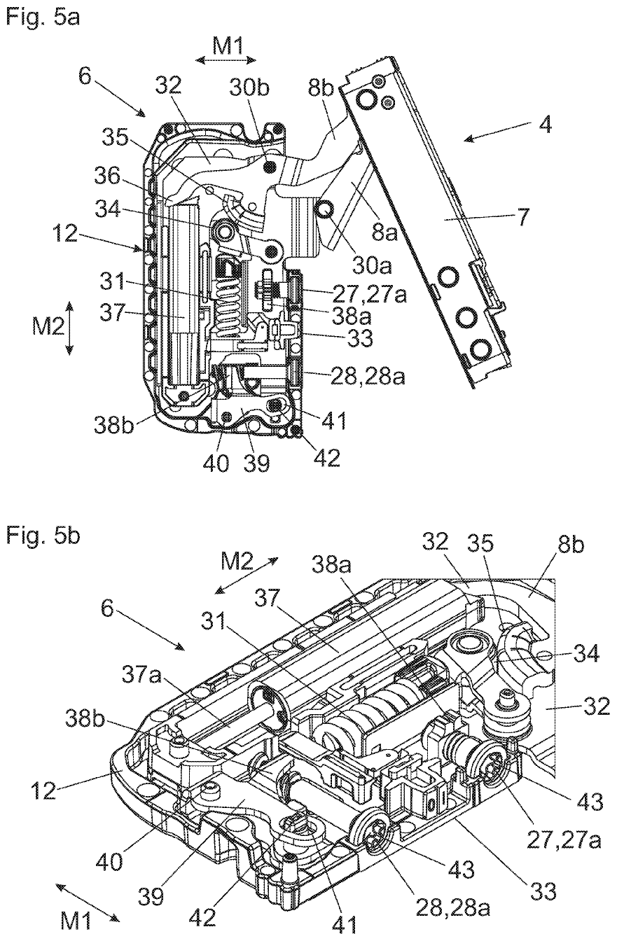

FIG. 5a shows a top view of the first fitting portion 6 with the base body 12 and the bearing body 32 arranged therein. The first hinge lever 8a is pivotally connected to the bearing body 32 via a first hinge axis 30a, and/or the second hinge lever 8b is pivotally connected to the bearing body 32 via a second hinge axis 30b.

For applying a force to the hinge lever 8b, a force storage member 31 (for example at least one compression spring) is provided. The hinge lever 8b (and therewith the second fitting portion 7) is movable by the force storage member 31 into an open-end position and/or into a closed end position. The force storage member 31 operates on a rotationally supported pressure roller 34 which is displaceable on a setting contour 35 arranged on one of the hinge levers 8a, 8b upon a movement of the hinge levers 8a, 8b.

For dampening a closing movement of the fitting 4, a damping device 37 (for example with a piston-cylinder-unit) is provided. The damping device 37 can be pressurized by a lever arm 36 of the hinge lever 8b upon a closing movement of the fitting 4.

By a first adjustment device 27, a position of the bearing body 32 is adjustable in a first adjustment direction M1, preferably in a direction extending perpendicular to the front face 33 of the first fitting portion 6. The first adjustment device 27 can include a rotatable adjustment element 27a which is in threading engagement with a bearing 38a of the bearing body 32.

By a second adjustment device 28, a position of the bearing body 32 is adjustable in a second adjustment direction M2 extending transversely to the first adjustment direction M1, preferably in a direction extending parallel to the front face 33 of the first fitting portion 6.

The second adjustment device 28 can include a rotatable adjustment element 28a having a threaded portion which is in threading engagement with a bearing 38b of a pivoting member 39, the pivoting member 39 being pivotable about a pivoting axis 40.

The pivoting member 39 includes an opening 41, preferably an elongated hole, in which a guide element 42, preferably a pin, of the bearing body 32 is movably guided. By rotating the adjustment element 28a of the second adjustment device 28, the pivoting member 39 is tiltable about the pivoting axis 40. As a result, the guide element 42 of the bearing body 32 is displaceable in a direction extending substantially parallel to the front face 33 of the first fitting portion 6. In this way, the lateral position of the bearing body 32 relative to the outer base body 12 can be aligned, and, therewith, the position of the pivoting element 3 in a lateral direction relative to the stationary carrier 2.

For improved guidance, the guide element 42 is movable along a linear guide 46 of the base body 12, as shown in FIG. 3. Thereby, the linear guide 46 is aligned substantially parallel to the front face 33 of the first fitting portion 6.

FIG. 5b shows a perspective view of the first fitting portion 6 with the base body 12 and with the bearing body 32 arranged in the base body 12. The force storage member 31 (for example including a compression spring) presses via the pressure roller 34 against a setting contour 35 of the hinge lever 8b. As a result, the force of the force storage member 31 can be transmitted to the hinge lever 8b in a dosed manner, according to a predetermined progression. Upon closing the fitting 4, the lever arm 32 of the hinge lever 8b abuts against the damping device 37, and a housing (for example a cylinder) of the damping device 37 is pushed relative to a stationary piston rod 37a so as to decelerate the closing movement of the fitting 4.

The bearing body 32 is pivotally supported relative to the base body 12 about a pivoting axis 40. The bearing body 32 is at least partially movable about the pivoting axis 40 upon an actuation of at least one actuating device 27, 28, preferably upon an actuation of both actuating devices 27, 28.

The adjustment element 27a of the first actuating device 27 is in threading engagement with a bearing 38a of the bearing body 32, whereas the adjustment element 28a of the second adjustment device 28 is in threading engagement with a bearing 38b of the pivoting member 39.

According to preferred embodiments, the pivoting axis 40
is arranged adjacent to a side face of the first fitting portion 6, the side face protruding transversely from the front face 33, and/or
is arranged on the first fitting portion 6 with a distance from a hinge axis 30b of at least one hinge lever 8b, preferably the distance substantially corresponding to a width of the front face 33 of the first fitting portion 6 in a direction extending parallel to the second adjustment direction M2.

The adjustment element 27a, 28a of at least one adjustment device 27, 28
can have a longitudinal direction, and the rotatably supported adjustment element 27a, 28a is non-displaceably supported in the longitudinal direction or is displaceably supported in the longitudinal direction, and/or
includes a receiver 43 for a tool, preferably a screwdriver, and/or
is configured to be actuated from a front face 33 of the first fitting portion 6.

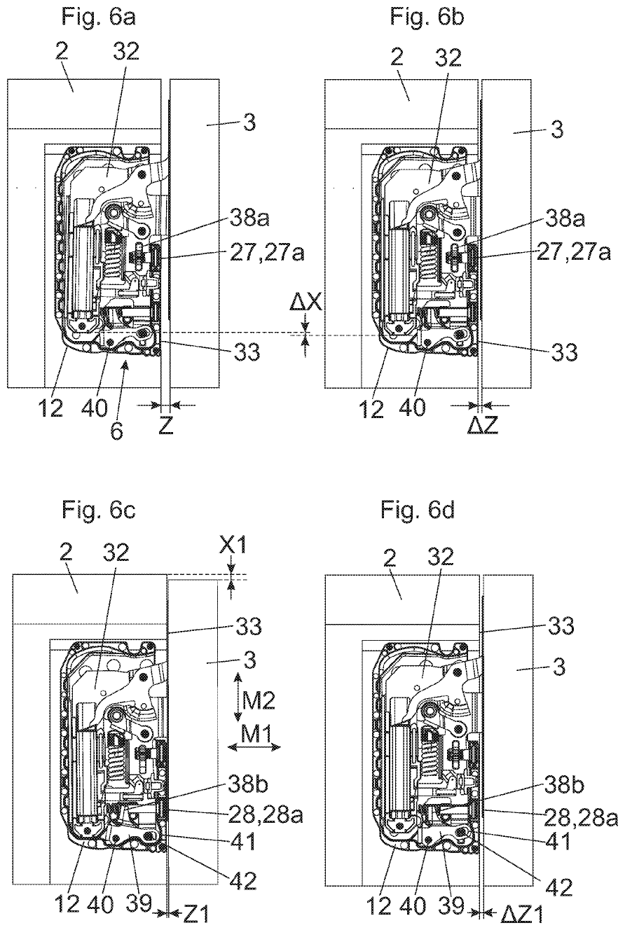

FIG. 6a and FIG. 6b show the first fitting portion 6 with the base body 12 and with the bearing body 32 arranged on the base body 12. A position of the bearing body 32 relative to the base body 12 is adjustable by the two adjustment devices 27, 28.

The first adjustment device 27 includes a rotatable adjustment element 27a which is in a threading engagement with a bearing 38a of the bearing body 32. By rotating the adjustment element 27a of the first adjustment device 27, the bearing body 32 is adjustable in a direction extending perpendicular to the front face 33 of the first fitting portion 6. By an actuation of the first adjustment device 27, a depth distance Z of the pivoting element 3 relative to the stationary carrier 2 is adjustable, and the pivoting element 3 adopts a different depth distance ΔZ relative to the stationary carrier 2. However, upon an actuation of the first adjustment device 27, the bearing body 32 is also entrained in a direction extending parallel to the front face 33. It can be seen that the position of the bearing body 32 in FIG. 6b, in a direct comparison with FIG. 6a, has also been entrained by the lateral distance ΔX.

FIG. 6c and FIG. 6d show the first fitting portion 6 with the base body 12 and with the bearing body 32 adjustable within the base body 12. The second adjustment device 28 includes a rotatable adjustment element 28a which is in threading engagement with a bearing 38b of the pivoting member 39, the pivoting member 39 being tiltable about the pivoting axis 40. By a rotation of the adjustment element 28a of the second adjustment device 28, the bearing body 32 is adjustable in a direction extending parallel to the front face 33 of the first fitting portion 6. By an actuation of the second adjustment device 28, a lateral position X1 of the pivoting element 3 relative to the stationary carrier 2 is adjustable. In FIG. 6d, the pivoting element 3 adopts a different lateral position X1 relative to the stationary carrier 2. However, upon an actuation of the second adjustment device 28, the bearing body 32 is also entrained in a direction extending transversely, preferably perpendicular, to the front face 33. It can be seen that the depth distance Z1 according to FIG. 6c and the depth distance ΔZ1 according to FIG. 6d vary in size.

By a rotation of the adjustment element 28a of the second adjustment device 28, the pivoting member 39 is tilted about the pivoting axis 40, and the pivoting member 39 urges the guide element 42 of the bearing body 32 via the opening 41 in a direction extending parallel to the front face 33.

Due to the coupling of the two adjustment devices 27, 28, the play of the bearing body 32 within the base body 12 can be reduced, and the pivoting element 3 has an improved movement behavior.

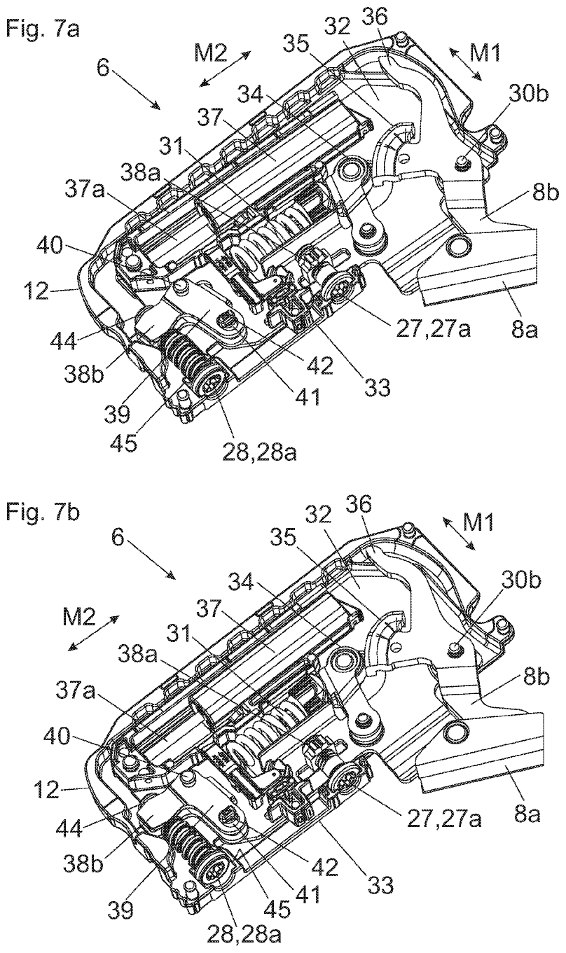

FIG. 7a shows a slightly modified embodiment of the first fitting portion 6 with the base body 12 and with the bearing body 32 arranged in the base body 12.

In contrast to the previous figures, the second adjustment device 28 with the rotatable adjustment element 28a for adjusting the bearing body 32 in a direction extending parallel to the front face 33 has a different configuration. With the previous figures, it is namely provided that the adjustment element 28a of the second adjustment device 28 is in threading engagement with the bearing 38b of the pivoting member 39 via a threaded portion. However, the mutual threading engagement, under certain circumstances, could cause that the rotatable adjustment element 28a and the pivoting member 39 tiltable about the pivoting axis 40 can get jammed with each other, in particular when longer adjustment paths are provided.

According to the embodiment of FIG. 7a, 7b, the rotatable adjustment element 28a has a threadless portion 44 on which the pivoting member 39 is supported, preferably via the bearing 39b. The adjustment element 28a has a longitudinal direction, and the adjustment element 28a is displaceable in the longitudinal direction, preferably in a direction extending parallel to the front face 33 of the first fitting portion 6.

For displaceably supporting the adjustment element 28a, a longitudinal guide 45 is provided, the longitudinal guide 45 being preferably arranged on the base body 12. The longitudinal guide 45 extends substantially perpendicular to the front face 33 of the first fitting portion 6.

FIG. 7b shows the first fitting portion 6, in which the bearing body 32, in a direct comparison with FIG. 7a, adopts a different position relative to the base body 12. The different positions of the adjustment element 28a relative to the longitudinal guide 45 can also be seen.

An actuation of the second adjustment device 28 in the second adjustment direction M2, preferably in a direction extending parallel to the front face 33, also leads to a movement of the bearing body 32 in the first movement direction M1, preferably in a direction extending perpendicular to the front face 33.

An actuation of the first adjustment device 27 in the first adjustment direction M1, preferably in a direction extending perpendicular to the front face 33, thus also leads to a movement of the bearing body 32 in the second movement direction M2, preferably in a direction extending parallel to the front face 33.

1. A fitting for movably supporting a pivoting element, in particular a furniture part, a door or a window, relative to a stationary carrier, the fitting comprising:
a first fitting portion configured to be fixed to a, preferably substantially horizontally aligned, panel of the carrier,
a second fitting portion configured to be fixed to the pivoting element, the second fitting portion being pivotally connected to the first fitting portion via at least one hinge lever,
wherein the first fitting portion includes at least one base body and at least one bearing body adjustable relative to the base body, the at least one hinge lever being supported on the bearing body,
a first adjustment device for adjusting the at least one bearing body relative to the base body in a first adjustment direction, preferably in a direction extending transversely to a front face of the first fitting portion,
at least a second adjustment device for adjusting the at least one bearing body relative to the base body in a second adjustment direction extending transversely to the first adjustment direction, preferably in a direction extending parallel to the front face of the first fitting portion,
wherein the two adjustment devices are coupled to each other such that the bearing body, upon an adjustment of the bearing body in the first adjustment direction with the aid of the first adjustment device, is also entrainable at least over a region in the second adjustment direction.

2. The fitting according to claim 1, wherein the two adjustment devices are coupled to each other such that the bearing body, upon an adjustment of the bearing body in the second adjustment direction with the aid of the second adjustment device, is also entrainable at least over a region in the first adjustment direction.

3. The fitting according to claim 1, wherein the at least one bearing body is pivotally supported relative to the base body about a pivoting axis.

4. The fitting according to claim 3, wherein the pivoting axis:
is arranged adjacent to a side face of the first fitting portion, the side face protruding transversely from the front face, and/or
is arranged on the first fitting portion with a distance from a hinge axis of at least one hinge lever, preferably wherein the distance substantially corresponds to a width of the front face of the first fitting portion in a direction extending parallel to the second adjustment direction.

5. The fitting according to claim 1, wherein at least one adjustment device, preferably both adjustment devices, includes or include at least one rotationally supported adjustment element.

6. The fitting according to claim 5, wherein at least one adjustment element, preferably both adjustment elements:
has a longitudinal direction, wherein the rotationally supported adjustment element is non-displaceably supported in the longitudinal direction or is displaceably supported in the longitudinal direction, and/or
includes a receiver for a tool, preferably a screwdriver, and/or
is configured to be actuated from a front face of the first fitting portion.

7. The fitting according to claim 5, wherein at least one adjustment element includes a threaded portion which is in threading engagement with a pivoting member pivotable about a pivoting axis.

8. The fitting according to claim 5, wherein at least one adjustment element includes a threadless portion on which a pivoting member for adjusting the bearing body is supported.

9. The fitting according to claim 7, wherein the pivoting member includes an opening, preferably an elongated hole, in which a guide element, preferably a pin, of the bearing body is movably guided.

10. The fitting according to claim 9, wherein the guide element is displaceably supported along a linear guide of the base body.

11. The fitting according to claim 1, wherein at least one adjustment element is in engagement with a bearing so as to adjust the bearing body, preferably wherein the adjustment element is arranged on the base body and the bearing is arranged on the bearing body.

12. The fitting according to claim 1, wherein the first fitting portion includes a front face, wherein the first adjustment direction extends transversely, preferably substantially perpendicular, to the front face of the first fitting body, and/or wherein the second adjustment direction extends substantially parallel to the front face of the first fitting portion.

13. The fitting according to claim 1, wherein the first fitting portion includes a mounting body configured to be fixed to or within the stationary carrier, the mounting body having a, preferably pocket-shaped, housing, wherein the base body of the fitting is configured to be releasably connected to the mounting body, preferably releasably lockable by at least one locking device.

14. The fitting according to claim 13, wherein the base body of the first fitting portion, in a connected condition with the mounting body, is at least partially, preferably for the most part, received within the housing of the mounting body.

15. The fitting according to claim 1, wherein the base body has a height extension and a longitudinal extension, wherein the longitudinal extension of the base body is at least three times, preferably at least six times, larger than the height extension.
